(19) United States
(12) Patent Application Publication
(10) Pub. No.: US 2026/0363364 A1
(43) Pub. Date: Nov. 19, 2026

(54) HEATED CLOTHING INCLUDING BRAIDED CABLE

(71) Applicant: MILWAUKEE ELECTRIC TOOL CORPORATION, Brookfield, WI (US)

(72) Inventors: Bradley J. VAN WAGONER, Germantown, WI (US); Matthew D. STROMMEN, Greendale, WI (US); Luke I. BRADLEY, Oconomowoc, WI (US); Action FAN, Suzhou (CN); Carina ZENG, Suzhou (CN)

(21) Appl. No.: 19/681,293

(22) Filed: May 19, 2026

Related U.S. Application Data
(60) Provisional application No. 63/807,987, filed on May 19, 2025.

(51) Int. Cl. A41D 13/005; H05B 1/02; H05B 3/34

(52) U.S. Cl. CPC A41D 13/0051; H05B 1/0272; H05B 3/342; H05B 2203/036

(57) ABSTRACT

An article of clothing includes a body configured to be worn by a user, a heating array supported by the body, a power source, and a wire connecting the power source to the heating array. The wire has a round cross-section.

### CROSS-REFERENCE TO RELATED APPLICATIONS

This application claims priority to U.S. Provisional Patent Application No. 63/807,987, filed May 19, 2025, the entire contents of which are incorporated herein by reference.

### FIELD OF THE INVENTION

The present disclosure generally relates to articles of clothing and, more particularly, to heated clothing. The present disclosure also relates to heated clothing including round and/or braided wires.

### BACKGROUND

Garments such as base layers, which are designed to be worn beneath a user’s clothing, can offer enhanced warmth and comfort in cold conditions. A base layer creates an extra insulating layer to help retain body heat and improve overall thermal protection.

### SUMMARY

In one independent embodiment, the invention provides an article of clothing including a body configured to be worn by a user, a heating array supported by the body, a power source, and a wire connecting the power source to the heating array. The wire has a round cross-section.

In another independent embodiment, the invention provides an article of clothing including a body having an upper region configured to be worn around a user’s waist and hips, and legs extending from the upper region. The article of clothing also includes a heating array supported by the body, a power source, a wire connecting the power source to the heating array, and a wire holding member positioned on the upper region. The wire is routed through the wire holding member.

In another independent embodiment, the invention provides an article of clothing including a body configured to be worn by a user, a heating array supported by the body, a battery compartment having a battery receptacle configured to receive a battery pack, a control button assembly supported by the body, and a wire connecting the control button assembly and the heating array to the battery pack. The wire is a braided wire having a round cross-section.

Other independent aspects of the disclosure will become apparent by consideration of the detailed description, claims, and accompanying drawings.

### BRIEF DESCRIPTION OF THE DRAWINGS

FIG. 1A is a front view of an article of clothing.

FIG. 1B is a rear view of the article of clothing of FIG. 1A.

FIG. 2A is a front schematic view of the article of clothing of FIG. 1A.

FIG. 2B is a rear schematic view of the article of clothing of FIG. 1A.

FIG. 3 is an electrical block diagram for the article of clothing of FIG. 1A.

FIG. 4 is a cross-sectional view of a cable for use with the article of clothing of FIG. 1A.

FIG. 5A is a front view of another article of clothing.

FIG. 5B is a rear view of the article of clothing of FIG. 5A.

FIG. 6A is a front schematic view of the article of clothing of FIG. 5A.

FIG. 6B is a first side schematic view of the article of clothing of FIG. 5A.

FIG. 6C is a rear schematic view of the article of clothing of FIG. 5A.

FIG. 6D is a second side schematic view of the article of clothing of FIG. 5A.

FIG. 7 is an electrical block diagram for the article of clothing of FIG. 5A.

FIG. 8 is a cross-sectional view of a cable for use with the article of clothing of FIG. 5A.

### DETAILED DESCRIPTION

Before any independent embodiments of the invention are explained in detail, it is to be understood that the invention is not limited in its application to the details of construction and the arrangement of components set forth in the following description or illustrated in the following drawings. The invention is capable of other independent embodiments and of being practiced or of being carried out in various ways.

Use of “including” and “comprising” and variations thereof as used herein are meant to encompass the items listed thereafter and equivalents thereof as well as additional items. Use of “consisting of” and variations thereof as used herein is meant to encompass only the items listed thereafter and equivalents thereof.

Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not listed.

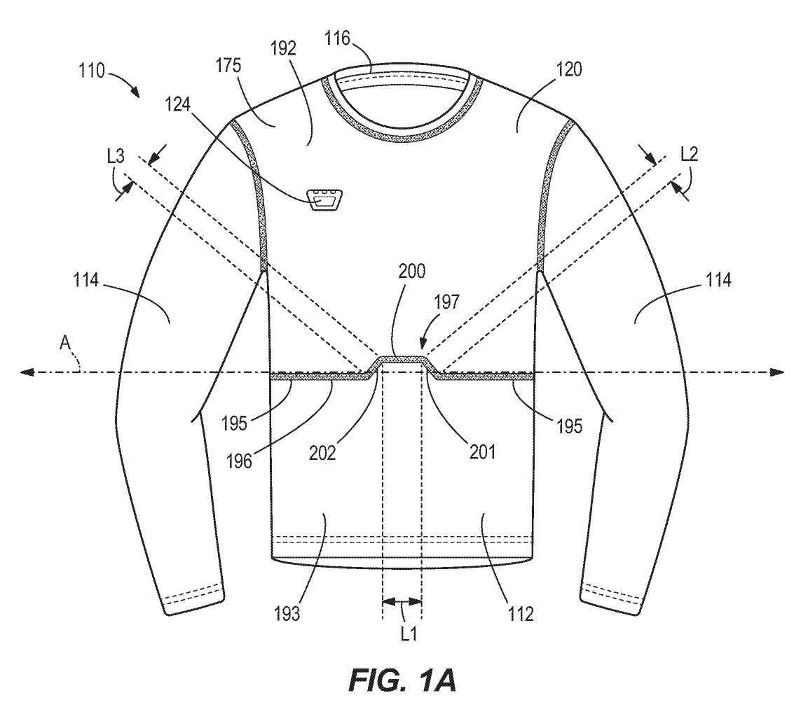

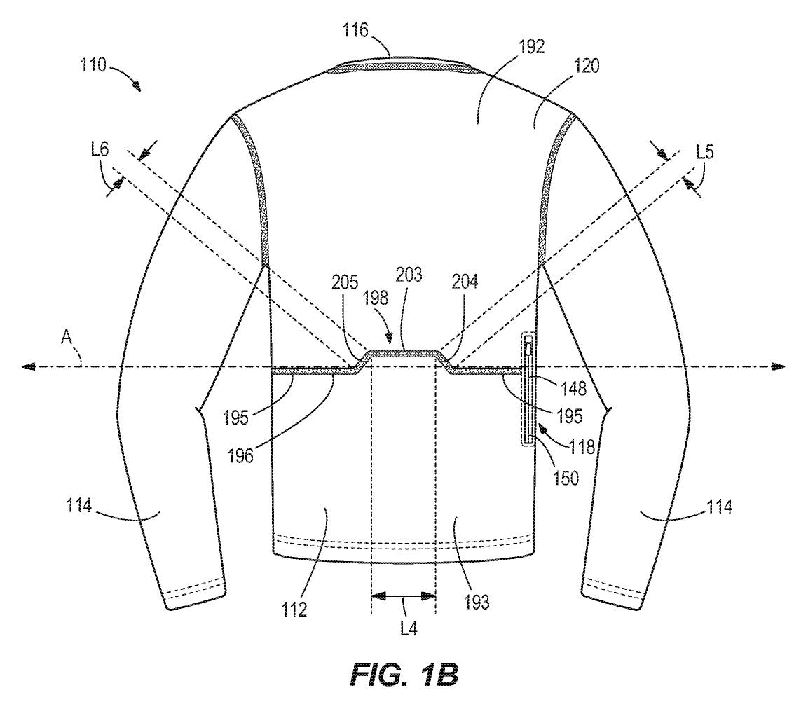

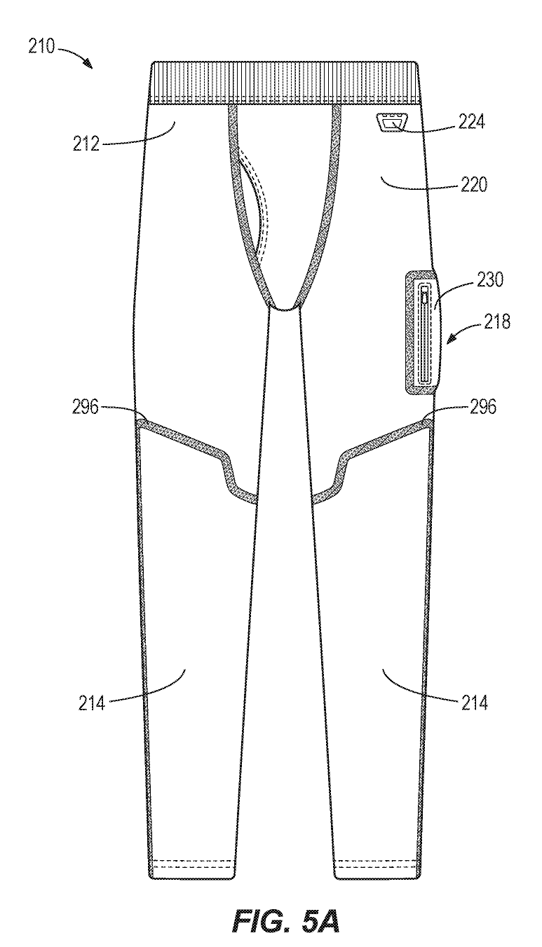

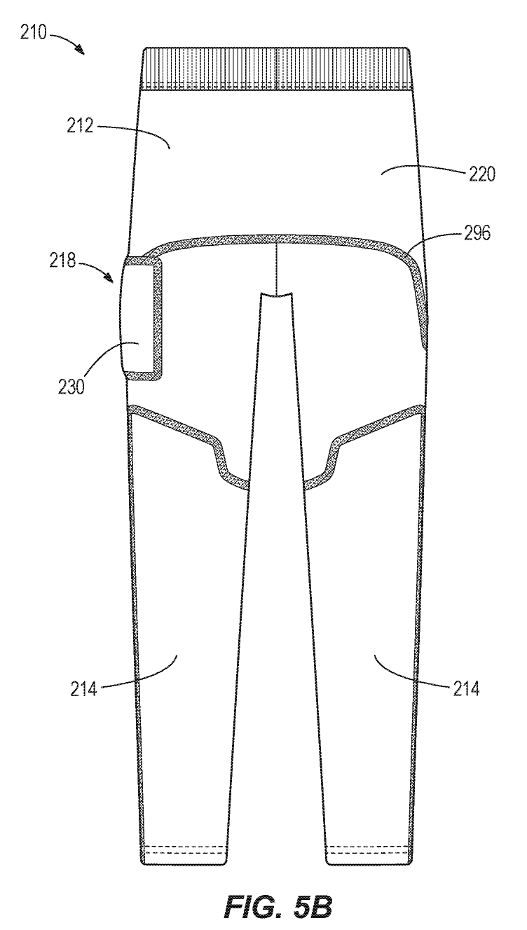

FIGS. 1A-3 illustrate an article of clothing, such as a heated base layer 110, having electrical components to be controlled. The heated base layer 110 may be further understood as top layer for a user to wear, for example, under typical clothing. In the illustrated construction, the heated base layer 110 is configured to be worn under a user’s clothing (e.g., a shirt, jacket, etc.) and to cover a portion of the user’s body (e.g., torso, arms, etc.). A user is to be understood as the wearer of the heated base layer 110. The heated base layer 110 may be constructed in various sizes to fit a variety of users. In other constructions, the heated base layer 110 may be a bottom layer (see FIGS. 5A-8). In still other constructions, the article of clothing may be a different type of article of clothing, such as a non-base layer article of clothing.

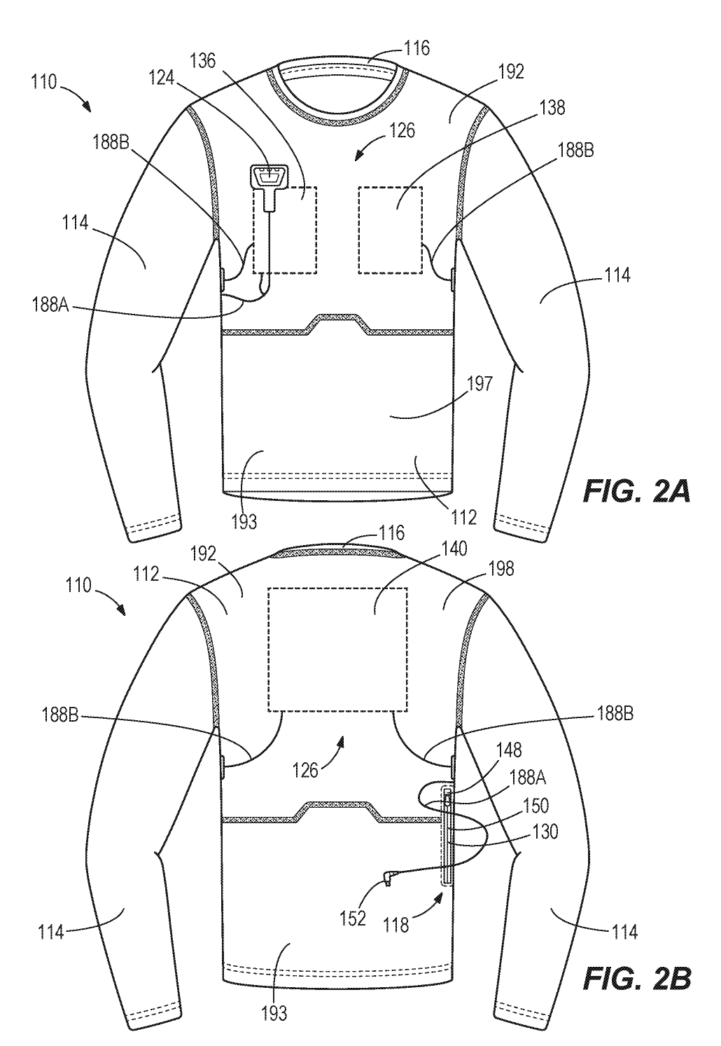

As illustrated in FIGS. 1A-2B, the heated base layer 110 may include at least a torso body 112. The heated base layer 110 may also include other typical shirt components such as arms 114, a collar 116, and a side pocket 118. In other constructions (not shown), the article of clothing may have another configuration (e.g., overalls, a vest, a hooded garment, a jacket, or any other type of article or gear that is worn on the torso). The heated base layer 110 may also include an outer shell 120 and an inner shell (not shown). In the illustrated implementation, the outer shell 120 may be made from a polyester material and may be constructed to protect the user from wind, rain, and other weather elements. In some implementations, the outer shell 120 has an outer surface that is exposed to the elements and that may be waterproof, windproof, or a combination thereof. The inner shell may provide an inner lining for the heated base layer 110 for additional warmth and comfort. In some implementations, the inner shell may line the inside of the heated base layer 110 including the torso body 112, the arms 114, the collar 116, and the pocket 118. In other implementations, the inner shell lines only select areas of the heated base layer 110. For example, in some implementations, the inner shell lines the torso body 112, but not the arms 114. The inner shell may be coupled to the outer shell 120 by sewing along at least the borders of the heated base layer 110.

The torso body 112 includes a top portion 192 and a bottom portion 193 which are attached to one another via a three (3) needle, five (5) thread cover stitch 196. The top portion 192 and the bottom portion 193 are generally separated by an axis A. The cover stitch 196 includes a circumferential portion 195 which extends around a circumference of the user’s torso and generally aligns with the axis A. The illustrated cover stitch 196 further includes a front portion 197 which is generally trapezoidal in shape and includes a straight-line segment 200, a first angled segment 201, and a second angled segment 202. The straight-line segment 200 extends parallel to the axis A. The first and second angled segments 201, 202 are angled relative to the axis A and the straight-line segment 200. In particular, the first and second angled segments 201, 202 are obliquely angled relative to the axis A and the straight-line segment 200. The first and second angled segments 201, 202 are also angled in opposite directions away from each other from the straight-line segment 200. The straight-line segment 200 extends between the first angled segment 201 and the second angled segment 202.

Similarly, the cover stitch 196 includes a rear portion 198 which is generally trapezoidal in shape and includes a straight-line segment 203, a first angled segment 204, and a second angled segment 205. The straight-line segment 203 extends parallel to the axis A. The first and second angled segments 204, 205 are angled relative to the axis A and the straight-line segment 203. In particular, the first and second angled segments 204, 205 are obliquely angled relative to the axis A and the straight-line segment 203. The first and second angled segments 204, 205 are also angled in opposite directions away from each other from the straight-line segment 203.

As shown in FIG. 1A, the straight-line segment 200 of the front portion 197 has a length L1 measured parallel to axis A. The first angled segment 201 of the front portion 197 has a length L2 measured from the circumferential portion 195 to the straight-line segment 200. The second angled segment 202 of the front portion 197 has a length L3 measured from the circumferential portion 195 to the straight-line segment 200. The lengths L2 and L3 extend at angles to the length L1. More particularly the lengths L2 and L3 may extend at an angle of 45 degrees to the length L1. In some embodiments, the length L1 of the straight-line segment 200 may be between about 1 and 5 inches (between about 2.54 centimeters and about 12.7 centimeters). For example, the length L1 may be about 2.25 inches (about 5.715 centimeters). In some embodiments, the length L2 of the first angled segment 201 may be between about 0.5 inches and about 4 inches (between about 1.27 centimeters and about 10.16 centimeters). For example, the length L2 may be about 2.12 inches (about 5.38 centimeters). In some embodiments, the length L3 of the second angled segment 202 may be between about 0.5 inches and about 4 inches (between about 1.27 centimeters and about 10.16 centimeters). For example, the length L3 may be about 2.12 inches (about 5.38 centimeters).

As shown in FIG. 1B, the straight-line segment 203 of the rear portion 198 has a length L4 measured parallel to the axis A. The first angled segment 204 of the front portion 197 has a length L5 measured from the circumferential portion 195 to the straight-line segment 203. The second angled segment 205 of the front portion 197 has a length L6 measured from the circumferential portion to the straight-line segment 203. The lengths L5 and L6 extend at angles to the length L4. More particularly the lengths L5 and L6 may extend at an angle of 45 degrees to the length L4. In some embodiments, the length L4 of the straight-line segment 203 may be between about 1 and 5 inches (between about 2.54 centimeters and about 12.7 centimeters). For example, the length L1 may be about 3.25 inches (about 8.255 centimeters). In some embodiments, the length L5 of the first angled segment 204 may be between about 0.5 inches and about 4 inches (between about 1.27 centimeters and about 10.16 centimeters). For example, the length L5 may be about 2.03 inches (about 5.16 centimeters). In some embodiments, the length L6 of the second angled segment 205 may be between about 0.5 inches and about 4 inches (between about 1.27 centimeters and about 10.16 centimeters). For example, the length L6 may be about 2.03 inches (about 5.16 centimeters).

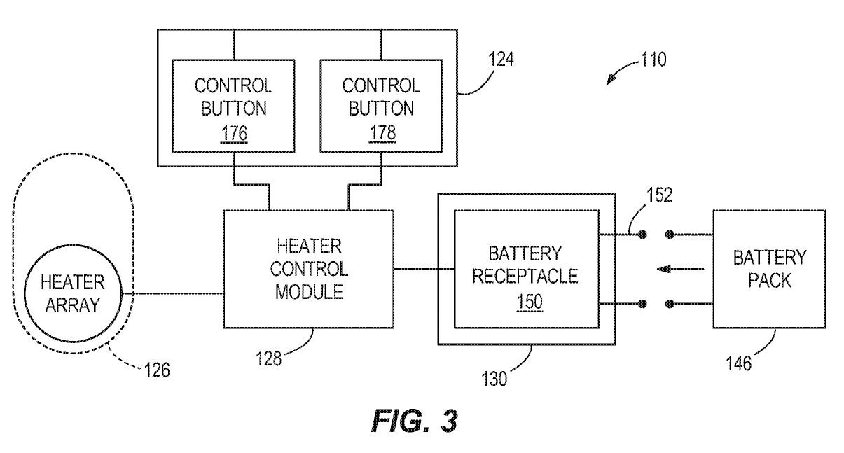

As shown in FIGS. 2A and 2B, the illustrated heated base layer 110 also includes a control button assembly 124 supported by the body 112, a heating array 126 supported by the body 112, a heater control module 128 (FIG. 3), and a battery compartment 130. The control button assembly 124 may also be referred to as a user interface. The heating array 126 may include any suitable arrangement of one or more heaters. The heating array 126 may include a right chest heating module 136, a left chest heating module 138, and a back heating module 140.

The heating array 126 is controlled via the heater control module 128 and the control button assembly 124. The user interacts with control buttons 176, 178 of the control button assembly 124 to control operation of the heating array 126. The heating array 126 receives electrical energy from a battery pack 146 (FIG. 3) received in the battery compartment 130 and converts said electrical energy into heat. In other implementations, the heating array 126 can include fewer or more heater modules and/or the heater modules may be positioned elsewhere throughout the heated base layer 110. In some implementations, the heated base layer 110 includes a single heater module in the torso body 112 instead of multiple heater modules.

As shown in FIG. 2B, the battery compartment 130 is located on a side portion of the torso body 112. In other implementations, the battery compartment 130 may be located elsewhere on the heated base layer 110. In the illustrated construction, the battery compartment 130 is the side pocket 118 formed in the top layer. In some constructions, the battery compartment 130 may be an additional pocket formed in the top layer. The battery compartment 130 includes a zipper 148, providing selective access by a user to the battery compartment 130 in order to access the battery pack 146 and other electrical components. In other constructions, the battery compartment 130 may include other suitable fasteners (e.g., snaps, buttons, clips, Velcro, etc.) to provide selective access to the battery compartment 130.

The battery compartment 130 includes a battery receptacle 150 configured to receive the battery pack 146. The battery receptacle 150 may include a USB type plug 152. The battery receptacle 150 may also be used for communicating with and charging other electronic devices, such as a digital media player, an iPod^{®}, a smartphone, or another similar device. In other constructions, the battery receptacle 150 may be other types of plugs or may be a battery holder that physically receives and connects to the battery pack 146. The battery receptacle 150 receives electrical energy from the battery pack 146 and supplies the electrical energy to the heater control module 128 for distribution to the heating array 126.

In the illustrated implementation, the battery receptacle 150 is configured to connect to the battery pack 146. The battery pack 146 may also be referred to as a power source. The battery pack 146 may be a 12-volt lithium-based battery pack and may also be operable to power other devices, such as a power tool (not shown; e.g., a drill, a pipe cutter, an impact driver, a saw, etc.), a non-motorized device (not shown; e.g., a sensing device (a camera, a sensor, a multi-meter, a scanner, etc.)), etc. having a similarly-configured receptacle as the battery receptacle 150.

In other implementations, the battery receptacle 150 may have a different construction to accommodate different type of battery packs (e.g., having a different voltage, chemistry, interface, etc.). For example, in some implementations (not shown), the battery receptacle 150 may receive an 18-volt battery pack or another type of battery pack.

As shown in FIG. 3, the heater control module 128 receives inputs from the control button assembly 124 and selectively powers the heating array 126. The heater control module 128 is coupled to a chest portion 175 (FIG. 1A) of the heated base layer 110. In other implementations, the heater control module 128 may be located elsewhere on the heated base layer 110. The heater control module 128 may be configured to monitor a plurality of conditions of the heated base layer 110 including, but not limited to, an amount of current drawn by the heating array 126.

The heater control module 128 includes, for example, a microprocessor, microcontroller, etc., and is configured to communicate with a controller of the battery pack 146. In the illustrated implementation, the battery controller provides information to the heater control module 128 related to a battery pack temperature and/or voltage level. The heater control module 128 and the battery controller may also include low voltage monitors and state-of-charge monitors. The monitors are used to determine whether the battery pack 146 is experiencing a low voltage condition, which may prevent proper operation of the heating array 126 or if the battery pack 146 is in a state-of-charge that makes the battery pack 146 susceptible to being damaged. If such a low voltage condition or state-of-charge exists, the heating array 126 is shut down or the battery pack 146 (FIG. 3) is otherwise prevented from further discharging current to prevent the battery pack 146 from becoming further depleted and/or damaged.

The heater control module 128 receives a user input from the control button assembly 124 that specifies whether the heating array 126 is activated and may, in some implementations, specify particular heating modules 136-140 to be activated. For example, the control button assembly 124 may be activated to turn the heating array 126 on to automatically set to an initial predetermined thermal output setting. If the control button assembly 124 is already activated (e.g., pressed), the control button assembly 124 changes the operation of the heating modules 136-140. For example, the control button assembly 124 may be used for the heated base layer 110 to switch between a high setting, a medium setting, and low setting. The heating modules 136-140 provide a high, medium, and low thermal output, respectively. In some implementations, when the control button assembly 124 is first activated, the heated base layer 110 enters a pre-heat mode. The heated base layer 110 may remain in the pre-heat mode for a predetermined period of time before the heater control module 128 switches the heating modules 136-140 to the medium setting. The user may at any point adjust the thermal output setting with the control button assembly 124.

Referring back to FIG. 2A, the illustrated control button assembly 124 is located on the front of the heated base layer 110. The control button assembly 124 is positioned on an upper corner of the heated base layer 110 to provide ease of access to the user. In other implementations, the control button assembly 124 may be located elsewhere on the heated base layer 110, such as the upper right corner of the heated base layer 110. The control button assembly 124 is coupled to the heater control module 128 to provide the heater control module 128 with user input information to control the heating array 126.

As illustrated in FIGS. 2A and 2B, the heated base layer 110 also includes a cable 188 interconnecting the control button assembly 124, the heating array 126, and the battery pack 146. In the illustrated construction, the cable 188 includes a first cable segment 188A extending from the control button assembly 124 and the right chest heating module 136 to the plug 152 to connect the control button assembly 124 and the right chest heating module 136 to the battery pack 146. For example, the first cable segment 188A may be routed from the control button assembly 124, over the right chest heating module 136, under one of the arms 114, and to the battery receptacle 150. The cable 188 also includes second cable segments 188B extending between the heating modules 136-140 to connect the heating modules 136-140 together and to the control button assembly 124. For example, one of the second cable segments 188B may be routed from the right chest heating module 136, under one of the arms 114, and to the back heating module 140. In addition, another of the second cable segments 188B may be routed from the back heating module 140, under one of the arms 114, and to the left chest heating module 138. In the illustrated construction, the control button assembly 124 is coupled to or directly adjacent one of the heating modules (e.g., coupled to the right chest heating module 136 or directly adjacent the left chest heating module 138). As such, a cable segment does not extend from the control button assembly 124 to the heating array 126. In other constructions, the control button assembly 124 is spaced apart from the heating array 126. In such constructions, the cable 188 may include a third cable segment extending from the control button assembly 124 to one of the heating modules 136-140 to connect the control button assembly 124 to the heating array 126. In the illustrated construction, the cable segments 188A, 188B are discrete segments that interconnect the control button assembly 124, the heating array 126, and the battery pack 146. In other constructions, the cable 188 may be a continuous cable extending between the control button assembly 124, the heating array 126, and the battery pack 146.

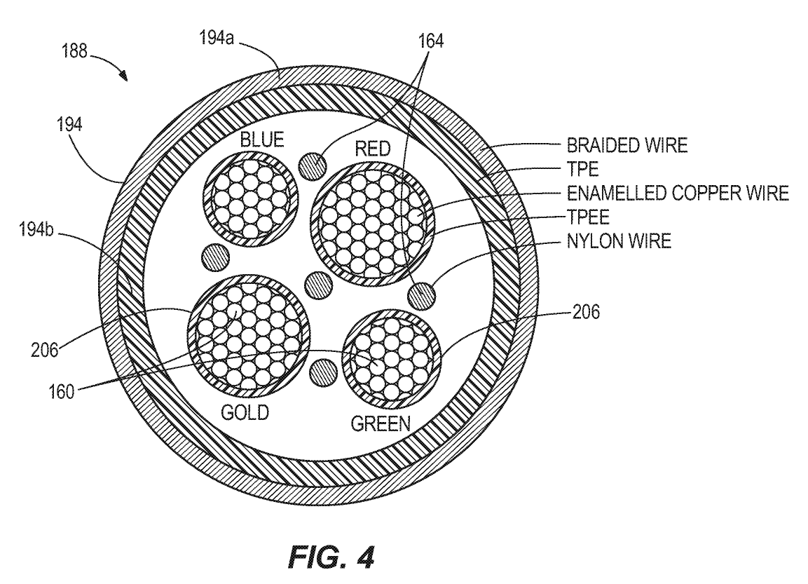

As shown in FIG. 4, the illustrated cable 188 is a braided wire. For example, the cable 188 may include a plurality of conducting wires 160 sheathed in an insulative material individually and collectively. In some implementations, the insulative material may be referred to as a shielding layer 194. The conducting wires 160 may each have a thermoplastic polyester elastomer (TPEE) layer. The cable 188 may further include a plurality of support wires 164 interspersed between the conducting wires 160 and sheathed within the shielding layer 194. The support wires 164 may be nylon wires configured to provide enhanced support and heat resistance within the cable 188. The shielding layer 194 is configured to contain the conducting wires 160 and reduce disorganization and tangling of the conducting wires 160. In the present embodiment, the shielding layer 194 is composed of a braided wire portion 194a surrounding a plastic portion 194b. The braided wire portion 194a includes thin wires woven into a mesh around the plastic portion 194b. In other embodiments, the braided wire portion 194a may be formed by weaving multiple strands of yarn, or any other suitable material, in a circular over-under pattern around the conducting wires 160. The plastic portion 194b is preferably formed from a thermoplastic elastomer (TPE), such as rubber or plastic to insulate the conducting wires 160 from the braided wire portion 194a. The shielding layer 194 may help protect the conducting wires 160. The shielding layer 194 may also increase a strength of the cable 188, yet still allow the cable 188 to remain flexible. The cable 188 may also include a sheath surrounding the shielding layer 194 and the conducting wires 160. The sheath may be a thin layer of insulating material, such as plastic or rubber. In other embodiments, the shielding layer 194 may be composed of any suitable material to insulate or protect the conducting wires 160 and/or the cable 188.

In the illustrated construction, the cable 188 may be rounded. That is, the cable 188 may have a round cross-section, rather than a flattened cross-section like cables of conventional heated clothing. For example, in the illustrated construction, the conducting wires 160 (and the support wires 164) are arranged in a multiple clusters 206, rather than in a series or line like a conventional cable. For example, each cluster 206 has multiple conducting wires 160 sheathed in the TPEE layer. In some constructions, the cable 188 may have a circular cross-section. In other constructions, the cable 188 may have an oval-shaped, egg-shaped, oblong-shaped, or other elongated round-shaped cross-section. The braided cable 188 with a round cross-section may provide comfort to the user wearing the heated base layer 110. For example, the braided cable 188 may be sufficiently flexible to be routed between components of the heated base layer 110, while the round cross-section may allow the cable 188 to roll along the shells / fabric of the heated base layer 110 as the user moves.

FIGS. 5A-8 illustrate an article of clothing according to another embodiment of the disclosure. The article of clothing is similar to the article of clothing described above with reference to FIGS. 1A-4. As such, features of the article of clothing of FIGS. 5A-8 corresponding with features of the article of clothing of FIGS. 1A-4 are given like reference numerals plus ‘100’.

FIGS. 5A and 5B illustrate the present embodiment, in which the article of clothing is a heated base layer 210 configured to be worn under a user’s clothing (e.g., pants, trousers, etc.) and to cover a portion of the user’s body (e.g., legs, waist, etc.). The heated base layer 210 may include an upper portion 212 configured to be worn around the user’s waist and hips. The heated base layer 210 may also include other typical pant components such as legs 214 and a side pocket 218. In other constructions (not shown), the article of clothing may have another configuration (e.g., overalls, a vest, a hooded garment, or any other type of article or gear that is worn by the user). The heated base layer 210 may also include an outer shell 220 and an inner shell (not shown). In the illustrated implementation, the outer shell 220 may be made from a polyester material and may be constructed to protect the user from wind, rain, and other weather elements. In some implementations, the outer shell 220 has an outer surface that is exposed to the elements and that may be waterproof, windproof, or a combination thereof. The inner shell provides an inner lining for the heated base layer 210 for additional warmth and comfort. In some implementations, the inner shell lines the inside of the pants including the upper portion 212, the legs 214, and the pocket 218. In other implementations, the inner shell lines only select areas of the heated base layer 210. For example, in some implementations, the inner shell lines the upper portion 212, but not the legs 214. The inner shell may be coupled to the outer shell 220 by sewing along at least the borders of the heated base layer 210. The heated base layer 210 includes a three (3) needle, five (5) thread cover stitch 296, which extends in a zig-zag pattern across each leg 214 and around a rear portion of the upper portion 212.

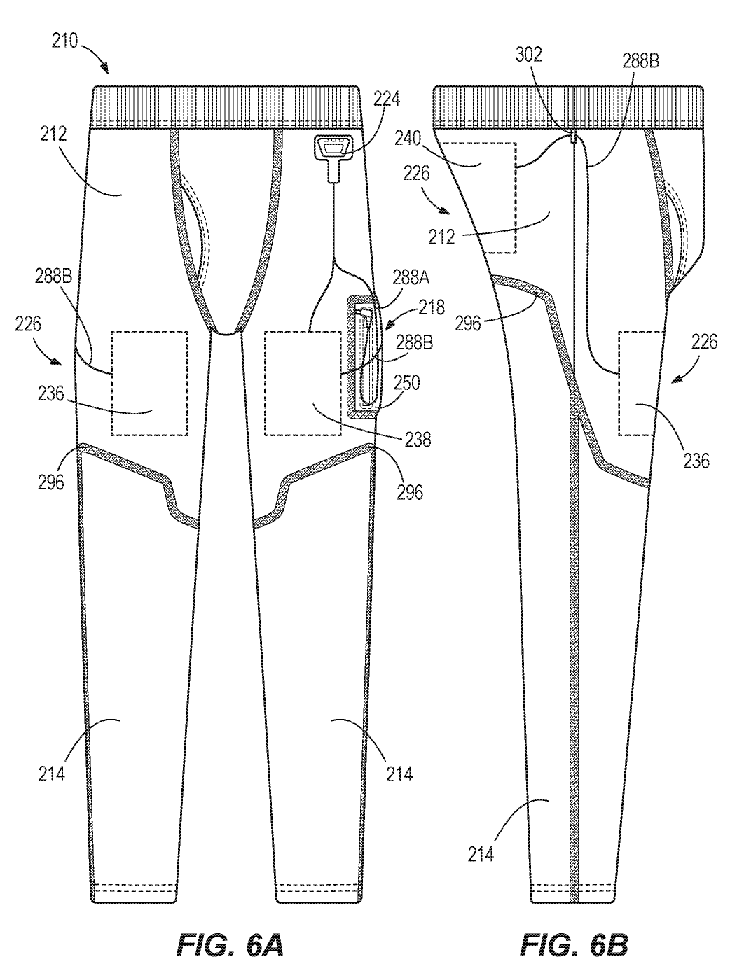

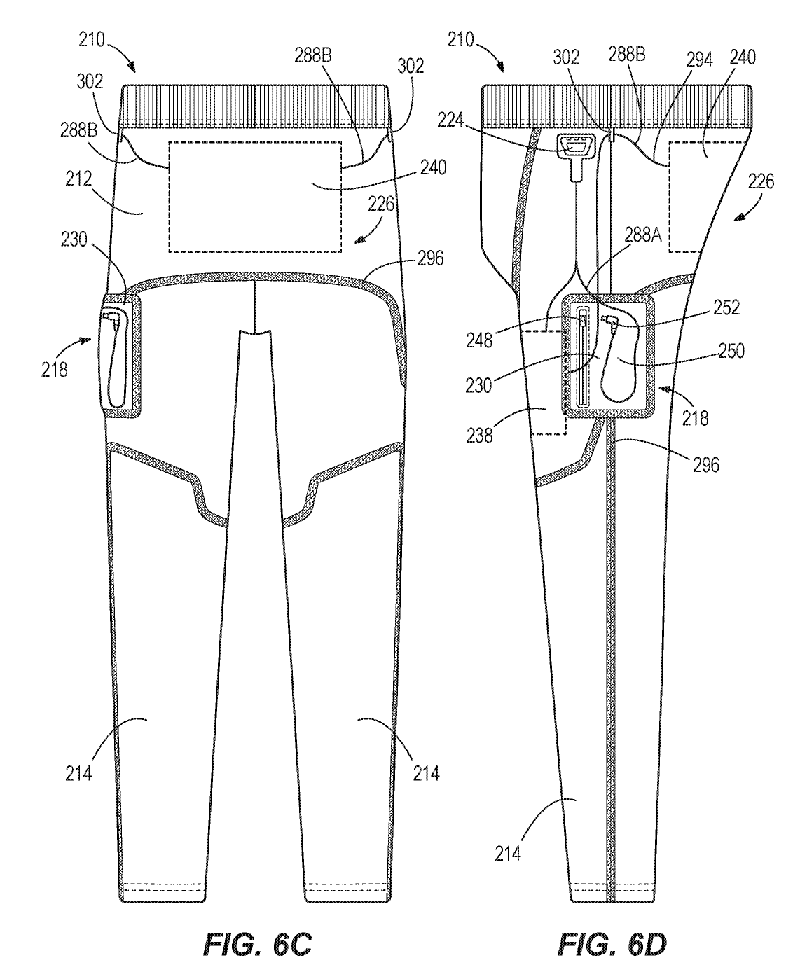

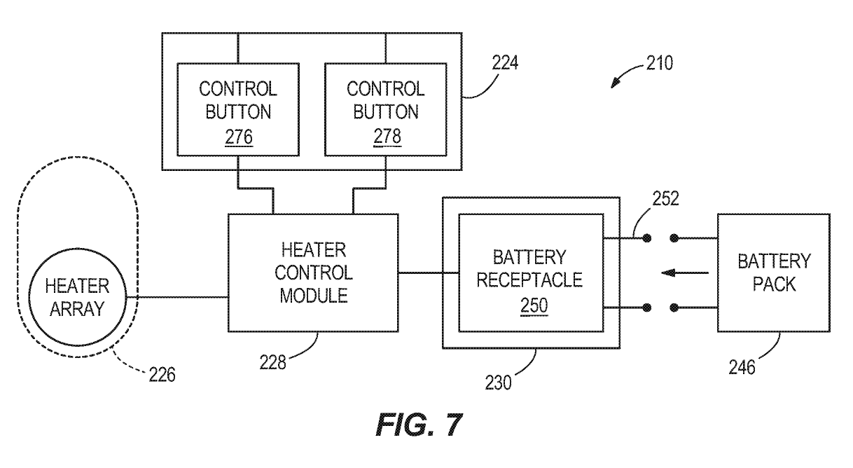

As shown in FIGS. 6A-6D, the illustrated heated base layer 210 also includes a control button assembly 224, a heating array 226, a heater control module 228 (FIG. 7), and a battery compartment 230. The control button assembly 224 may also be referred to as a user interface. The heating array 226 may include any suitable arrangement of one or more heaters. The heating array 226 may include a right leg heating module 236, a left leg heating module 238, and a rear heating module 240. The heating array 226 may include resistive heating coils formed of carbon fibers, high-density carbon fibers, or other heating devices.

The heating array 226 is controlled via the heater control module 228 and the control button assembly 224. The user interacts with control buttons 276, 278 of the control button assembly 224 to control operation of the heating array 226. The heating array 226 receives electrical energy from a battery pack 246 (FIG. 7) received in the battery compartment 230 and converts said electrical energy into heat. In other implementations, the heating array 226 can include fewer or more heater modules and/or the heater modules may be positioned elsewhere throughout the heated base layer 210. In some implementations, the heated base layer 210 includes a single heater module in the upper portion 212 instead of multiple heater modules.

As shown in FIG. 6D, the battery compartment 230 is the side pocket 218 located on a side portion of the upper portion 212. In some implementations, the battery compartment 230 may be an additional pocket located on the side portion of the upper portion 212. In other implementations, the battery compartment 230 may be located elsewhere on the heated base layer 210. In the illustrated construction, the battery compartment 230 is the side pocket 118 formed in the top layer. The battery compartment 230 includes a zipper 248, providing selective access by a user to the battery compartment 230 in order to access the battery pack 246 and other electrical components. In other constructions, the battery compartment 230 may include other suitable fasteners (e.g., snaps, buttons, clips, Velcro, etc.) to provide selective access to the battery compartment 230. The battery compartment 230 includes a battery receptacle 250 (FIG. 7) configured to receive the battery pack 246.

The battery receptacle 250 may include a USB type plug 252. The battery receptacle 250 may also be used for communicating with and charging other electronic devices, such as a digital media player, an iPod^{®}, a smartphone, or another similar device. In other constructions, the battery receptacle 250 may be other types of plugs or may be a battery holder that physically receives and connects to the battery pack 246. The battery receptacle 250 receives electrical energy from the battery pack 246 and supplies the electrical energy to the heater control module 228 for distribution to the heating array 226.

In the illustrated implementation, the battery receptacle 250 is configured to connect to the battery pack 246. The battery pack 246 may also be referred to as a power source. The battery pack 246 may be a 12-volt lithium-based battery pack and may also be operable to power other devices, such as a power tool (not shown; e.g., a drill, a pipe cutter, an impact driver, a saw, etc.), a non-motorized device (not shown; e.g., a sensing device (a camera, a sensor, a multi-meter, a scanner, etc.)), etc. having a similarly-configured receptacle as the battery receptacle 250.

In other implementations, the battery receptacle 250 may have a different construction to accommodate different type of battery packs (e.g., having a different voltage, chemistry, interface, etc.). For example, in some implementations (not shown), the battery receptacle 250 may receive an 18-volt battery pack or another type of battery pack.

The heater control module 228 receives inputs from the control button assembly 224 and selectively powers the heating array 226. The heater control module 228 is coupled to the upper portion 212 of the heated base layer 210. In other constructions, the heater control module 228 may be located elsewhere on the heated base layer 210. The heater control module 228 may be configured to monitor a plurality of conditions of the heated base layer 210 including, but not limited to, an amount of current drawn by the heating array 226.

The heater control module 228 includes, for example, a microprocessor, microcontroller, etc., and is configured to communicate with a controller of the battery pack 246. In the illustrated implementation, the battery controller provides information to the heater control module 228 related to a battery pack temperature and/or voltage level. The heater control module 228 and the battery controller may also include low voltage monitors and state-of-charge monitors. The monitors are used to determine whether the battery pack 246 is experiencing a low voltage condition, which may prevent proper operation of the heating array 226 or if the battery pack 246 is in a state-of-charge that makes the battery pack 246 susceptible to being damaged. If such a low voltage condition or state-of-charge exists, the heating array 226 is shut down or the battery pack 246 is otherwise prevented from further discharging current to prevent the battery pack from becoming further depleted and/or damaged.

The heater control module 228 receives a user input from the control button assembly 224 that specifies whether the heating array 226 is activated and may, in some implementations, specify particular heating modules 236-240 to be activated. For example, the control button assembly 224 may be activated to turn the heating array 226 on to automatically set to an initial predetermined thermal output setting. If the control button assembly 224 is already activated (e.g., pressed), the control button assembly 224 changes the operation of the heating modules 236-240. For example, the control button assembly 224 may be used for the heated base layer 210 to switch between a high setting, a medium setting, and a low setting. The heating modules 236-240 provide a high, medium, and low thermal output, respectively. In some implementations, when the control button assembly 224 is first activated, the heated base layer 210 enters a pre-heat mode. The heated base layer 210 may remain in the pre-heat mode for a predetermined period of time before the heater control module 228 switches the heating modules 236-240 to the medium setting. The user may at any point adjust the thermal output setting with the control button assembly 224.

Referring back to FIG. 6A, the illustrated control button assembly 224 is located on the front of the heated base layer 210. The control button assembly 224 is positioned on an upper corner of the upper portion 212 to provide ease of access to the user. In other implementations, the control button assembly 224 may be located elsewhere on the heated base layer 210, such as the upper right corner of the upper portion 212. The control button assembly 224 is coupled to the heater control module 228 to provide the heater control module 228 with user input information to control the heating array 226.

As illustrated in FIGS. 6A-6D, the heated base layer 210 also includes a cable 288 interconnecting the control button assembly 224, the heating array 226, and the battery pack 246. In the illustrated construction, the cable 288 includes a first cable segment 288A extending from the control button assembly 224 and the left leg heating module 238 to the plug 252 to connect the control button assembly 224 and the left leg heating module 238 to the battery pack 246. For example, the first cable segment 288A may be routed from the control button assembly 224 to the battery receptacle 250. The cable 288 also includes second cable segments 288B extending between the heating modules 236-240 to connect the heating modules 236-240 together and to the control button assembly 224. For example, one of the second cable segments 288B may be routed from the left leg heating module 238, up toward a side of the upper portion 212, through a first wire holding member 302, and to the rear heating module 240. In addition, another of the second cable segments 288B may be routed from the rear heating module 240, up toward a side of the upper portion 212, through a second wire holding member 302, and to the right leg heating module 236. The first and second wire holding members 302 are positioned on opposite sides of the upper portion 212. In some constructions, the wire holding members 302 may be located elsewhere on the upper portion 212 or the base layer 210. In the illustrated construction, each of the first and second wire holding members 302 may be a loop, a clip, a hook, and the like.

The wire holding members 302 are positioned between the heating modules 236-240 and near an upper end (e.g., the hip or waistband) of the upper portion 212. The cable 288 may be configured to slide through the wire holding members 302. In other words, the wire holding member 302 may be similar to a belt loop positioned near the waistband of the heated base layer 210. In other embodiments, the cable 288 may be fixed to the wire holding member 302. That is, the cable 288 may not be slidable or otherwise movable relative to the wire holding members 302. In the present embodiment, the heated base layer 210 includes two wire holding members 302, one on each side of the user’s waist (see e.g., FIG. 6C). In other embodiments, the heated base layer 210 may instead include only one, or more than two, wire holding member 302. Routing the cable 288 through the wire holding member 302 advantageously improves comfort for the user and inhibits bunching up of the cable 288, while also providing slack to accommodate movement.

In the illustrated construction, the control button assembly 224 is coupled to or directly adjacent one of the heating modules (e.g., the rear heating module 240). As such, a cable segment does not extend from the control button assembly 224 to the heating modules 236-240. In other constructions, the control button assembly 224 is spaced apart from the heating modules 236-240. In such constructions, the cable 288 may include a third cable segment extending from the control button assembly 224 to one of the heating modules to connect the control button assembly 224 to the heating array 226. In the illustrated construction, the cable segments 288A, 288B are discrete segments that interconnect the control button assembly 224, the heating array 226, and the battery pack 246. In other constructions, the cable 288 may be a continuous cable extending between the control button assembly 224, the heating array 226, and the battery pack 246.

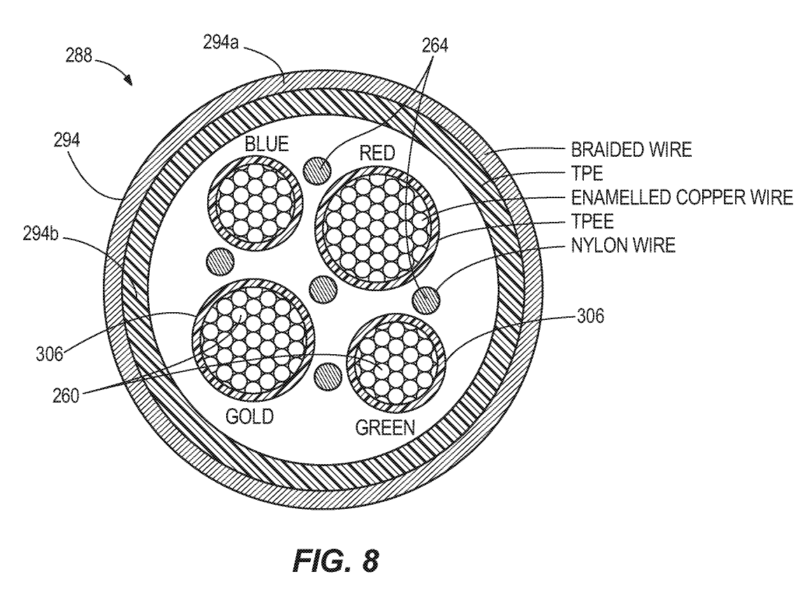

As shown in FIG. 8, the illustrated cable 288 is a braided wire. For example, the cable 288 may include a plurality of conducting wires 260 sheathed in an insulative material individually and collectively. In some implementations, the insulative material may be referred to as a shielding layer 294. The conducting wires 260 may each have a thermoplastic polyester elastomer layer (TPEE). The cable 288 may further include a plurality of support wires 264 interspersed between the conducting wires 260 and sheathed within the shielding layer 294. The support wires 264 may be nylon wires configured to provide enhanced support and heat resistance within the cable 288. The shielding layer 294 is configured to contain the conducting wires 260 and reduce disorganization and tangling of the conducting wires 260. In the present embodiment, the shielding layer 294 is composed of a braided wire portion 294a surrounding a plastic portion 294b. The braided wire portion 294a includes thin wires woven into a mesh around the plastic portion 294b. In other embodiments, the braided wire portion 294a may be formed by weaving multiple strands of yarn, or any other suitable material, in a circular over-under pattern around the conducting wires 260. The plastic portion 294b is preferably formed from a thermoplastic elastomer (TPE), such as rubber or plastic to insulate the conducting wires 260 from the braided wire portion 294a. The shielding layer 294 may help protect the conducting wires 260. The shielding layer 294 may also increase a strength of the cable 288, yet still allow the cable 288 to remain flexible. The cable 288 may also include a sheath surrounding the shielding layer 294 and the conducting wires 260. The sheath may be a thin layer of insulating material, such as plastic or rubber. In other embodiments, the shielding layer 294 may be composed of any suitable material to insulate or protect the conducting wires 260 and/or the cable 288.

In the illustrated construction, the cable 288 may be rounded. That is, the cable 288 may have a round cross-section, rather than a flattened cross-section like cables of conventional heated clothing. For example, in the illustrated construction, the conducting wires 260 (and the support wires 264) are arranged in multiple clusters 306, rather than in a series or line like a conventional cable. For example, each cluster 306 has multiple conducting wires 260 sheathed in the TPEE layer. In some constructions, the cable 288 may have a circular cross-section. In other constructions, the cable 288 may have an oval-shaped, egg-shaped, oblong-shaped, or other elongated round-shaped cross-section. The braided cable 288 with a round cross-section may provide comfort to the user wearing the heated base layer 210. For example, the braided cable 288 may be sufficiently flexible to be routed between components of the heated base layer 210, while the round cross-section may allow the cable 288 to roll along the shells/fabric of the heated base layer 210 as the user moves. The braiding of the cable 288 and/or the shielding layer 294 may be formed by weaving multiple strands of yarn, or any suitable material, in a circular over-under pattern around the conducting wires 160.

Although the invention has been described in detail with reference to certain preferred embodiments, variations and modifications exist within the scope and spirit of one or more independent aspects of the invention as described.

Various features and aspects of the invention are set forth in the following claims.

1. An article of clothing comprising:
a body configured to be worn by a user;
a heating array supported by the body;
a power source; and
a wire connecting the power source to the heating array, the wire having a round cross-section.

2. The article of clothing of claim 1, wherein the wire is a braided wire.

3. The article of clothing of claim 2, wherein the wire includes a shielding layer formed of insulative material and a plurality of conducting wires sheathed in the shielding layer, and wherein the shielding layer is composed of a braided wire portion and a plastic portion surrounded by the braided wire portion.

4. The article of clothing of claim 3, wherein the braided wire portion has thin wires woven into a mesh.

5. The article of clothing of claim 3, wherein the braided wire portion is formed of yarn strands that are weaved in a circular over-under pattern.

6. The article of clothing of claim 3, wherein the wire further includes a plurality of support wires interspersed between the plurality of conducting wires and also sheathed in the shielding layer.

7. The article of clothing of claim 1, further comprising a control button assembly supported by the body, and wherein the wire also connects the control button assembly to the power source and the heating array.

8. An article of clothing comprising:
a body having an upper portion configured to be worn around a user’s waist and hips, and legs extending from the upper portion;
a heating array supported by the body;
a power source;
a wire connecting the power source to the heating array; and
a wire holding member positioned on the upper portion, wherein the wire is routed through the wire holding member.

9. The article of clothing of claim 8, wherein the wire holding member is a loop.

10. The article of clothing of claim 8, wherein the wire is slidable relative to the wire holding member.

11. The article of clothing of claim 8, wherein the wire is fixed to the wire holding member.

12. The article of clothing of claim 8, further comprising a control button assembly supported by the body, and wherein the wire also connects the control button assembly to the power source and the heating array.

13. The article of clothing of claim 8, wherein the wire is a braided wire having a round cross-section.

14. An article of clothing comprising:
a body configured to be worn by a user;
a heating array supported by the body;
a battery compartment having a battery receptacle configured to receive a battery pack;
a control button assembly supported by the body; and
a wire connecting the control button assembly and the heating array to the battery pack,
the wire being a braided wire having a round cross-section.

15. The article of clothing of claim 14, wherein the battery compartment is a pocket formed on the body.

16. The article of clothing of claim 14, wherein the body has an upper portion configured to be worn around the user’s waist and hips, and legs extending from the upper portion.

17. The article of clothing of claim 16, wherein the heating array includes a right leg heating module, a left leg heating module, and a rear heating module.

18. The article of clothing of claim 14, wherein the body is configured to cover a portion of the user’s torso.

19. The article of clothing of claim 18, wherein heating array includes a right chest heating module, a left chest heating module, and a back heating module.

20. The article of clothing of claim 14, wherein the wire includes and a shielding layer formed of insulative material and a plurality of conducting wires sheathed in the shielding layer, and wherein the shielding layer is composed of a braided wire portion and a plastic portion surrounded by the braided wire portion.
